(19) United States
(12) Patent Application Publication
(10) Pub. No.: US 2026/0183741 A1
(43) Pub. Date: Jul. 2, 2026

(54) POROUS CARBON DIOXIDE CAPTURE AGENT AND ITS PREPARATION METHOD

(71) Applicant: INDUSTRY ACADEMY COOPERATION FOUNDATION CHANGWON NATIONAL UNIVERSITY, Changwon-Si (KR)

(72) Inventors: Sang Il Han, Haeundae-Gu, Busan (KR); Sanjit Gaikwad, Changwon-Si (KR)

(73) Assignee: INDUSTRY-ACADEMIC COOPERATION FOUNDATION CHANGWON NATIONAL UNIVERSITY, Changwon-Si (KR)

(21) Appl. No.: 18/861,278

(22) PCT Filed: Oct. 31, 2023
(86) PCT No.: PCT/KR2023/017111

§ 371 Date: Oct. 29, 2024

(30) Foreign Application Priority Data
May 24, 2023 (KR) 10-2023-0067162

(51) Int. Cl. B01J 20/22; B01D 53/04; B01D 53/62; B01J 20/28; B01J 20/30

(52) U.S. Cl. CPC B01J 20/226; B01D 53/04; B01D 53/62; B01J 20/28064; B01J 20/28073; B01J 20/30; B01D 2257/504

(57) ABSTRACT

The disclosure relates to a method of preparing a porous carbon dioxide capture agent including adding a transition metal precursor, an alkali metal precursor, and an organic acid to water to prepare a metal organic framework precursor aqueous solution; reflux condensing the prepared metal organic framework precursor aqueous solution; and drying the condensed metal organic framework precursor aqueous solution, and a porous carbon dioxide capture agent prepared according thereto.

### TECHNICAL FIELD

The disclosed invention relates to a porous carbon dioxide capture agent and a method preparing the same, and in particular, to a porous carbon dioxide capture agent using an environmentally friendly synthesis method and a method for producing the same.

### BACKGROUND ART

CO₂ causes global warming and extreme weather. About 45% of CO₂ in the environment comes from various industries such as thermal power plants, cement, and steel production. Atmospheric CO₂ levels have increased from 280 ppm in the early 1800s to over 400 ppm in 2018, and recent studies predict that CO₂ levels could reach at least 550 ppm by 2050 and 950 ppm by 2100. Global efforts are being made to control atmospheric CO₂ concentrations by using non-carbon energy sources and reducing the use of fossil fuels. However, current energy generation technologies based on fossil fuels are still being utilized. Therefore, carbon capture and storage (CCS) is one of the promising technologies to control atmospheric CO₂ concentrations.

In recent years, many technologies have been established for CO₂ capture, including physical adsorption, chemical absorption, cryogenic distillation, and membrane separation. Among these, chemical absorption is commonly used for CO₂ capture, which is performed using amine aqueous solutions because of its simple operation. However, this chemical absorption method has several disadvantages, such as toxicity, solution loss, equipment corrosion, and the need for a lot of energy for regeneration. In other words, the challenge is to develop a promising adsorbent with high CO₂ capacity and selectivity, competitive production cost, and almost no environmental impact.

To solve the above challenges, adsorbents such as activated carbon, zeolites, mesoporous silica, covalent organic frameworks (COFs), and metal organic frameworks (MOFs) have been used as CO₂ adsorbents.

Among these, metal-organic frameworks are nanoporous structures with very well-defined pore sizes, high surface areas, pore volumes, and rigid structures. In addition, the pore size and the chemical environment within the pores can be easily controlled by selecting appropriate organic ligands, i.e., bidentate compounds, and they have the advantages of excellent heat resistance and chemical resistance. Porous metal-organic frameworks consist of metal oxide complexes and organic linkers, and the coordination structures formed from these metal ion moieties and organic ligands can form various framework structures, ranging from simple molecular forms through self-assembly to linear primary, plate-like secondary, and complex three-dimensional structures. A typical synthetic method is a solvothermal synthesis method, which uses a polar solvent to dissolve the precursors of each component at an appropriate concentration, puts them in a sealed container, and heats them to synthesize them by the pressure generated by themselves.

However, these synthetic methods are very energy-consuming and very inefficient because the nucleation or crystallization process is very slow, and it usually takes several days or more to obtain a completely crystalline MOF compound. In addition, the existing inefficient synthesis methods of porous MOFs are pointed out as an obstacle to industrial application because they greatly burden the manufacturing cost. Furthermore, these typical synthetic methods have limitations in surface area and adsorption capacity, and there is an issue that they cause environmental pollution due to the use of excessive organic solvents. Therefore, the above-mentioned methods have had issues in industrial use.

### DISCLOSURE

### Technical Problem

The present invention has been made to solve the above problems, and aims to provide a porous carbon dioxide capture agent and a method for producing the same, which can reduce the burden of manufacturing costs by reducing the use of organic solvents and can be produced in an environmentally friendly manner.

### Solution to Problem

In order to achieve this purpose, in one general aspect, the present invention provides a method of preparing a porous carbon dioxide capture agent including: adding a transition metal precursor, an alkali metal precursor, and an organic acid to water to prepare a metal organic framework precursor aqueous solution; reflux condensing the prepared metal organic framework precursor aqueous solution; and drying the condensed metal organic framework precursor aqueous solution.

The transition metal precursor may include dimethyl zinc, diethyl zinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate.

The alkali metal precursor may include at least one substance selected from a group of potassium hydroxide, sodium hydroxide, lithium oxide, barium oxide, potassium carbonate, sodium carbonate, lithium carbonate, barium carbonate, sodium methoxide, sodium ethoxide, potassium ethoxide and potassium isopropoxide.

The organic acid may be at least one substance selected from a group of acetic acid, formic acid, citric acid, oxalic acid, and ascorbic acid.

The transition metal precursor and the alkali metal precursor may be included in a molar ratio of 1:1 to 1:5.

In the reflux condensation, a heating temperature may be 80 to 120° C.

In the reflux condensation, a heating time may be 5 to 10 hours.

The drying may be performed in a vacuum.

Additionally, in order to achieve this purpose, in another general aspect, the present invention provides a porous carbon dioxide capture agent formed using a composition comprising a transition metal precursor, an alkali metal precursor, and an organic acid.

A specific surface area of the porous carbon dioxide capture agent may be 750 to 1000 m²/g.

A pore volume of the porous carbon dioxide capture agent may be 0.6 to 1.0 cm³/g.

A CO₂/N₂ selectivity of the porous carbon dioxide capture agent may be 110 to 130.

X-ray diffraction (XRD) spectral peaks (2θ) of the porous carbon dioxide capture agent formed may appear at 7.4°, 11.26°, 13.61°, 15.5°, 21.19°, 25.28°, 26.22°, 27.99°, 28.8°, 35.63° and 37.17°.

### Effects of Invention

A method for preparing a porous carbon dioxide capture agent according to the present invention can be environmentally friendly, as it uses only pure water as a solvent for synthesis.

Additionally, a method for preparing a porous carbon dioxide capture agent according to the present invention can be suitable for mass production through a simple preparation method.

Furthermore, a porous carbon dioxide capture agent prepared according to the method of the present invention can exhibit high CO₂/N₂ selectivity.

### BRIEF DESCRIPTION OF DRAWINGS

FIG. 1 is a flow chart showing a process of preparing a porous carbon dioxide capture agent of the present invention.

FIG. 2 is a schematic diagram showing the crystal structure of a porous carbon dioxide capture agent prepared according to an embodiment of the present invention.

FIG. 3 is a SEM image of a porous carbon dioxide capture agent prepared according to an embodiment of the present invention.

FIG. 4 is an X-ray diffraction (XRD) spectrum of a porous carbon dioxide capture agent prepared according to an embodiment of the present invention.

FIG. 5 is a graph showing six types of adsorption isotherms according to the International Union of Pure and Applied Chemistry (IUPAC).

FIG. 6 is a graph showing the N₂ adsorption isotherm of the porous carbon dioxide capture agent prepared according to an embodiment of the present invention.

FIG. 7 is a graph showing CO₂ and N₂ adsorption isotherms of a porous carbon dioxide capture agent prepared according to an embodiment of the present invention.

FIG. 8 is a graph showing the CO₂/N₂ selectivity of a porous carbon dioxide capture agent prepared according to an embodiment of the present invention.

FIG. 9 is a graph showing the CO₂ adsorption isotherm of a porous carbon dioxide capture agent prepared according to an embodiment of the present invention.

### BEST MODE FOR IMPLEMENTATION OF THE INVENTION

The present invention can have various modifications and various embodiments, and specific embodiments are illustrated in the drawings and specifically described in the detailed description. However, this is not intended to limit the present invention to specific embodiments, and it should be understood that it includes all modifications, equivalents, or substitutes included in the spirit and technical scope of the present invention.

Throughout this specification, whenever a part is said to “comprise” or “include” a component, this does not exclude other components, but rather includes other components, unless otherwise stated.

The terms “about”, “substantially”, etc. used in this specification are used in the sense of a numerical value or a value close to that value when manufacturing and material tolerances inherent in the meanings mentioned are presented, and are used to prevent unscrupulous infringers from unfairly using the disclosures that mention exact or absolute values to help understanding the present application. In addition, throughout this specification, “step of ˜” does not mean “step for ˜.”

Since a person having ordinary knowledge in the technical field of the present invention can make various applications through the gist of the present invention, the scope of the rights of the present invention is not limited to the following examples. The scope of the rights of the present invention extends to parts that are obvious for a person having ordinary knowledge in the technical field of the present invention to easily substitute or change using conventional technology based on the matters described in the patent claims.

Hereinafter, the present invention will be described in more detail with reference to the attached drawings when necessary.

### <Method for Preparing Porous Carbon Dioxide Capture Agent>

As a means to achieve the above-described purpose, the present invention provides a method for preparing a porous carbon dioxide capture agent.

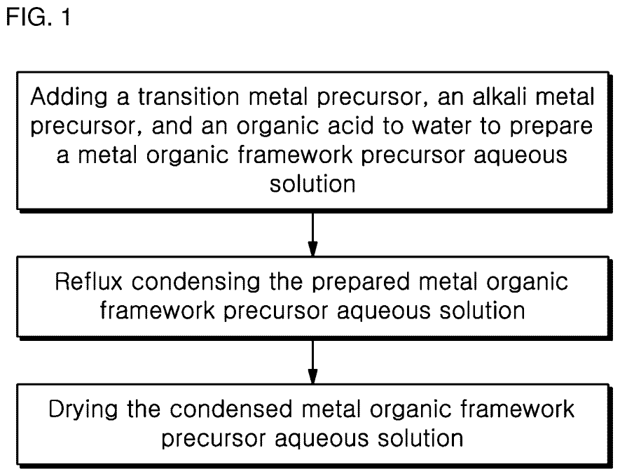

FIG. 1 is a flow chart showing the preparation process of the porous carbon dioxide capture agent of the present invention. Referring to FIG. 1, it can be confirmed that the porous carbon dioxide capture agent of the present invention includes: adding a transition metal precursor, an alkali metal precursor, and an organic acid to water to prepare a metal organic framework precursor aqueous solution; circulating and condensing the prepared metal organic framework precursor aqueous solution; and drying the condensed metal-organic framework precursor aqueous solution.

Metal-organic frameworks (MOFs) are porous materials in which metal ions or clusters containing metals are linked by organic ligands, and are a type of coordination polymer. The MOFs form a three-dimensional structure, maintaining porosity while maintaining strong bonds, and can perform various functions such as gas storage, catalysts, drug delivery, and chemical sensors.

The above circulating condensation is also called reflux condensation, and the reflux refers to the operation of condensing the vapor generated by heating into a liquid state and returning it to its original state. To prevent volatile substances or solvents from becoming vapor and volatilizing while continuing the heating, a cooler is attached to the top of the reaction vessel to condense the vaporized substances into liquid and return them to the original reaction vessel. The cooler used for this purpose is called a reflux condenser, and this operation can promote the reaction while boiling the solution. The reflux condenser is used to change the physical state of the vapor released from the heated solvent back to liquid through a straight or spiral circulating cooling method. It has the advantage of being able to heat the mixture for a long time by reducing the loss of solvent.

Furthermore, since the porous carbon dioxide capture agent of the present invention uses only pure water as a solvent, it can be prepared through an environmentally friendly preparation method.

Here, the transition metal precursor may include dimethyl zinc, diethyl zinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, but is not limited thereto.

Here, the alkali metal precursor may include at least one substance selected from a group consisting of potassium hydroxide, sodium hydroxide, lithium oxide, barium oxide, potassium carbonate, sodium carbonate, lithium carbonate, barium carbonate, sodium methoxide, sodium ethoxide, potassium ethoxide, and potassium isopropoxide, but is not limited thereto.

Here, the organic acid may be at least one substance selected from a group consisting of acetic acid, formic acid, citric acid, oxalic acid, and ascorbic acid, but is not limited thereto.

Here, the transition metal precursor and the alkali metal precursor may be included in a molar ratio of 1:1 to 1:5. If the molar ratio of the transition metal precursor and the alkali metal precursor is outside the above-described range (as a specific example, if the molar ratio of the transition metal precursor: the alkali metal precursor is 1:0.5 or 1:7), a problem may occur in which it is difficult to form the crystal structure of the target metal organic framework. Furthermore, since an additional process of filtering or removing the excess transition metal precursor and alkali metal precursor is required, a problem in which the process becomes complicated may occur. Therefore, in the present invention, it is preferable that the transition metal precursor and the alkali metal precursor are included in a molar ratio of 1:1 to 1:5.

Here, the heating temperature in the above-mentioned circulating condensation may be 80 to 120° C. If the heating temperature is less than 80° C., a problem may occur in which the crystal structure of the metal organic framework is not sufficiently formed. On the other hand, if the heating temperature exceeds 120° C., it is not economical because it does not exhibit an improved effect compared to when the heating temperature is 80 to 120° C. Accordingly, in the present invention, the heating temperature is preferably 80 to 120° C.

Here, the heating time in the above-mentioned reflux condensation may be 5 to 10 hours. If the heating time is less than 5 hours, a problem may occur in which the crystal structure of the metal-organic framework is not sufficiently formed. On the other hand, if the heating time exceeds 10 hours, a change in the crystal structure of the metal organic framework may occur, and thus, a problem in which the CO₂ adsorption capacity and CO₂/N₂ selectivity are reduced may occur. Accordingly, the heating time is preferably 5 to 10 hours.

The drying herein may be performed in a vacuum, but is not limited thereto.

### <Porous Carbon Dioxide Capture Agent>

In addition, as a means to achieve the above-described purpose, the present invention provides a porous carbon dioxide capture agent formed using a composition including a transition metal precursor, an alkali metal precursor, and an organic acid.

The types of the transition metal precursor, the alkali metal precursor, and the organic acid are the same as described above.

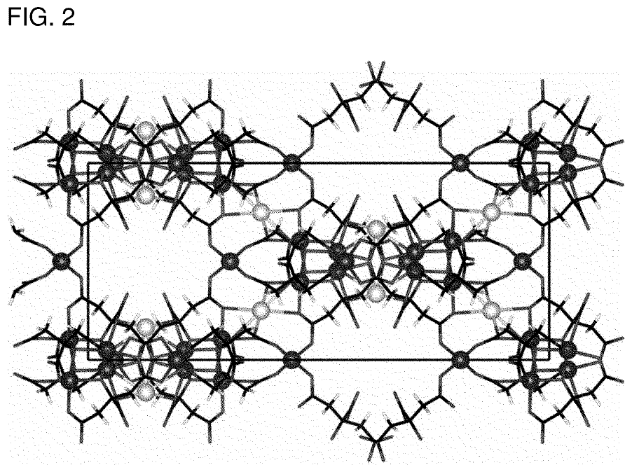

FIG. 2 is a schematic diagram showing the crystal structure of a porous carbon dioxide capture agent prepared according to an embodiment of the present invention.

Referring to FIG. 2, it can be confirmed that alkali metal cations are represented by cream-colored spheres, transition metal cations are represented by purple spheres, and in the case of organic acids, hydrogens are represented by white wires, carbons are represented by black wires, and oxygens are represented by red wires, respectively. Furthermore, it can be confirmed that pores are distributed as the porous carbon dioxide capture agent of the present invention is formed by the above-mentioned framework.

The porous carbon dioxide capture agent of the present invention has a porous crystal structure by forming a metal organic framework using a composition including a transition metal precursor, an alkali metal precursor, and an organic acid, and thus can be characterized by a large specific surface area and pore volume.

More specifically, the specific surface area of the porous carbon dioxide capture agent herein may be 750 to 1000 m²/g.

Additionally, the pore volume of the porous carbon dioxide capture agent herein may be 0.6 to 1.0 cm³/g.

The specific surface area and pore volume of the porous carbon dioxide capture agent of the present invention will be described in more detail in the {Examples and Evaluation} below.

Also, in order for a carbon dioxide capture agent to be evaluated as having excellent carbon dioxide adsorption capacity, it is desirable to exhibit high CO₂/N₂ selectivity, that is, excellent adsorption capacity for CO₂, while exhibiting low adsorption capacity for N₂. Here, the CO₂/N₂ selectivity of the porous carbon dioxide capture agent may be 110 to 130. Specific details regarding the CO₂/N₂ selectivity of the carbon dioxide adsorption composite of the present invention will also be described in more detail in the {Examples and Evaluation} below.

In addition, the porous carbon dioxide capture agent of the present invention may show XRD spectrum peaks having specific crystallinity by including the metal organic framework described above. Specific XRD spectrum peaks (2θ) of the porous carbon dioxide capture agent may appear at 7.4°, 11.26°, 13.61°, 15.5°, 21.19°, 25.28°, 26.22°, 27.99°, 28.8°, 35.63°, and 37.17°.

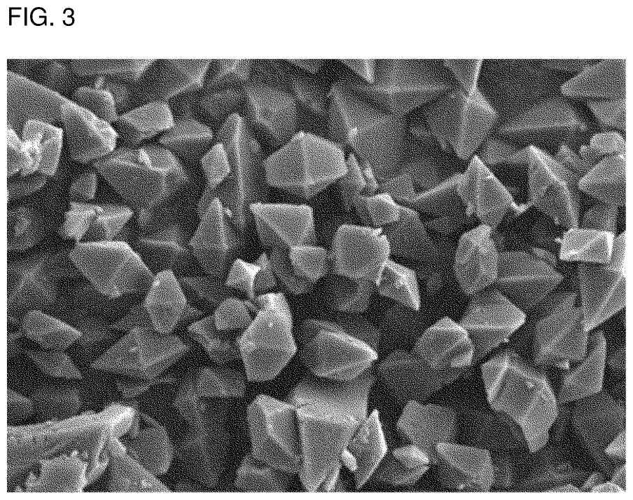

FIG. 3 is a SEM image of a porous carbon dioxide capture agent prepared according to an embodiment of the present invention. Referring to FIG. 3, it can be confirmed that the porous carbon dioxide capture agent of the present invention is composed of polygonal particles.

### Mode for Implementation of the Invention

Hereinafter, the claims of this specification will be described in more detail with reference to the attached drawings and embodiments. However, the drawings and embodiments presented in this specification may be modified in various ways by those skilled in the art and may have various forms, and the subject matter of the present invention is not limited to a specific disclosed form of the present invention, but should be viewed as including all equivalents or substitutes included in the spirit and technical scope of the present invention. In addition, the attached drawings are presented to help those skilled in the art understand the present invention more accurately, and may be depicted in an exaggerated or reduced form compared to reality.

### EXAMPLES AND EVALUATION

### Example

### 1. Comparison by Heating Time

### Example 1-1

Zn(CH₃COO)₂·2H₂O (4.6 g) and C₆H₈O₇·H₂O (4.4 g) were dissolved in 100 mL of water, and then KOH (3.51 g) was added to the same solution. The solution was stirred for 5 minutes and then transferred to a 250 mL round-bottom flask. The water temperature of the condenser was 5 to 10° C. The water condenser was set to maintain a temperature of 5 to 10° C. The reflux condensation was performed at 100° C. and 70 rpm for 7 hours. When the reaction was completed, the reaction mixture was cooled to room temperature to confirm the formation of a white precipitate. The precipitate was washed with ethyl ether (twice) and methanol (three times). The methanol solvent was exchanged three times a day for three days to remove impurities. The final product was dried under vacuum without heating for 2 hours, then heated at 100° C. under vacuum for 6 hours to obtain the desired product.

### Example 1-2

A porous carbon dioxide capture agent was prepared in the same manner as in Example 1-1, except that the above-mentioned reflux condensation was performed at 100° C. and 70 rpm for 8 hours (hereinafter referred to as “Example 1-2”).

### Example 1-3

A porous carbon dioxide capture agent was prepared in the same manner as in Example 1-1, except that the above-mentioned reflux condensation was performed at 100° C. and 70 rpm for 9 hours (hereinafter referred to as “Example 1-3”).

### Comparative Example 1-1

A porous carbon dioxide capture agent was prepared in the same manner as in Example 1-1, except that the reflux condensation was performed at 100° C. and 70 rpm for 3 hours (hereinafter referred to as “Comparative Example 1-1”).

### Comparative Example 1-2

A porous carbon dioxide capture agent was prepared in the same manner as in Example 1-1, except that the reflux condensation was performed at 100° C. and 70 rpm for 5 hours (hereinafter referred to as “Comparative Example 1-2”).

### 2. Comparison by Heating Temperature

### Example 2-1

A porous carbon dioxide capture agent was prepared in the same manner as in Example 1-1, except that the reflux condensation was performed at 100° C. and 70 rpm for 8 hours (hereinafter referred to as “Example 2-1”).

### Example 2-2

A porous carbon dioxide capture agent was prepared in the same manner as in Example 1-1, except that the reflux condensation was performed at 120° C. and 70 rpm for 8 hours (hereinafter referred to as “Example 2-2”).

### Comparative Example 2-1

A porous carbon dioxide capture agent was prepared in the same manner as in Example 1-1, except that the reflux condensation was performed at 60° C. and 70 rpm for 8 hours (hereinafter referred to as “Comparative Example 2-1”).

The details of the above-described examples and comparative examples are shown in Table 1 below.

TABLE 1

| Classification | Heating temperature(° C.) | Heating time(hours) |
|---|---|---|
| Example 1-1 | 100 | 7 |
| Example 1-2 | 100 | 8 |
| Example 1-3 | 100 | 9 |
| Comparative | 100 | 3 |
| Example 1-1 | | |
| Comparative | 100 | 5 |
| Example 1-2 | | |
| Example 2-1 | 100 | 8 |
| Example 2-2 | 120 | 8 |
| Comparative | 60 | 8 |
| Example 2-1 | | |

In addition, conventional metal organic frameworks were prepared according to known techniques.

### Comparative Example 3 (Zeolite 13X)

A metal organic framework was prepared based on the preparation method described in [S. Cavenati, C. A. Grande, A. E. Rodrigues, Adsorption equilibrium of methane, carbon dioxide, and nitrogen on zeolite 13X at high pressures, Journal of Chemical & Engineering Data 49 (4) (2004) 1095-1101] (hereinafter referred to as “Comparative Example 3”).

### Comparative Example 4 (Activated Carbon)

The activated carbon described in [R. P. Ribeiro, T. P. Sauer, F. V. Lopes, R. F. Moreira, C. A. Grande, A. E. Rodrigues, Adsorption of CO2, CH4, and N2 in activated carbon honeycomb monolith, Journal of Chemical & Engineering Data 53 (10) (2008) 2311-2317] was used (hereinafter referred to as “Comparative Example 4”).

### Comparative Example 5 (MOF-177)

A metal organic framework was prepared based on the preparation method described in [D. Saha, Z. Bao, F. Jia, S. Deng, Adsorption of CO2, CH4, N2O, and N2 on MOF-5, MOF-177, and zeolite 5A, Environmental science & technology 44 (5) (2010) 1820-1826] (hereinafter referred to as “Comparative Example 5”).

### Comparative Example 6 (MIL-96(Al)—Ca4)

A metal organic framework was prepared based on the preparation method described in [H. R. Abid, Z. H. Rada, Y. Li, H. A. Mohammed, Y. Wang, S. Wang, H. Arandiyan, X. Tan, S. Liu, Boosting CO 2 adsorption and selectivity in metal-organic frameworks of MIL-96 (Al) via second metal Ca coordination, RSC Advances 10 (14) (2020) 8130-8139] (hereinafter referred to as “Comparative Example 6”).

### <Evaluation>

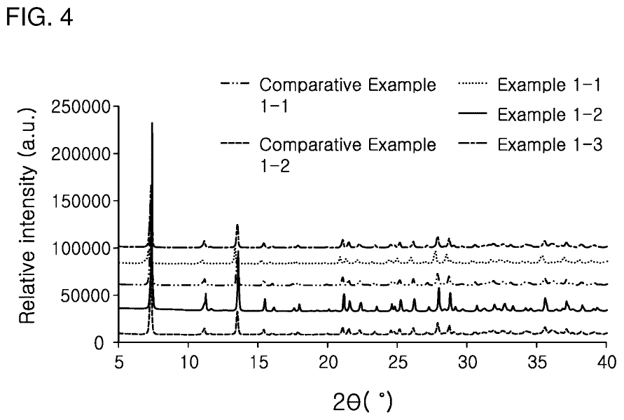

FIG. 4 is an X-ray diffraction (XRD) spectrum of a porous carbon dioxide capture agent prepared according to an embodiment of the present invention. The main peaks and the intensities of each peak shown in FIG. 4 are shown in Table 2 below.

TABLE 2

| Angle(2θ) | Intensity |
|---|---|
| 7.4 | 203064 |
| 13.61 | 65589 |
| 27.99 | 26271 |
| 28.8 | 21105 |
| 11.26 | 20451 |
| 21.19 | 19358 |
| 35.63 | 15280 |
| 26.22 | 15089 |
| 15.5 | 14906 |
| 37.17 | 11906 |
| 25.28 | 11828 |

Referring to FIG. 4 and Table 2, it can be confirmed that the XRD diffraction pattern shows main peaks at 7.4°, 13.61°, 27.99°, 28.8°, 11.26°, 21.19°, and 35.63°.

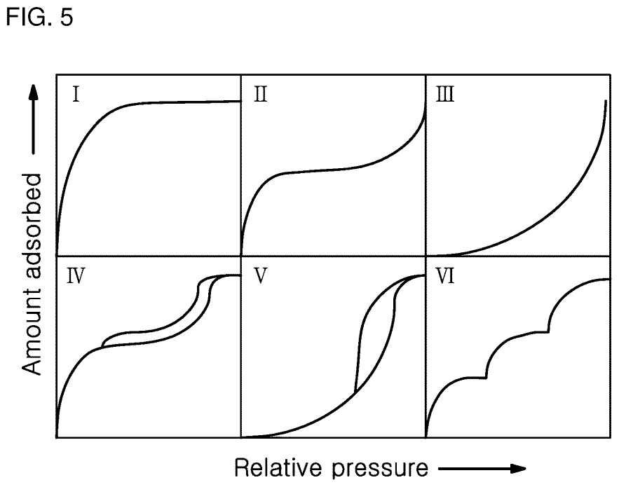

FIG. 5 is a graph showing six types of adsorption isotherms according to the International Union of Pure and Applied Chemistry (IUPAC). Referring to FIG. 5, it can be confirmed that Type I is an adsorption isotherm when there are mainly micropores, Type II is an adsorption isotherm when there are almost no micropores, Type III is an adsorption isotherm when the adsorbate is weak, Type IV is an adsorption isotherm when there are mainly mesopores and capillary condensation occurs, Type V is an adsorption isotherm when the adsorbate is weak and capillary condensation occurs, and Type VI is an adsorption isotherm when the gas is layered again on the adsorbed gas surface.

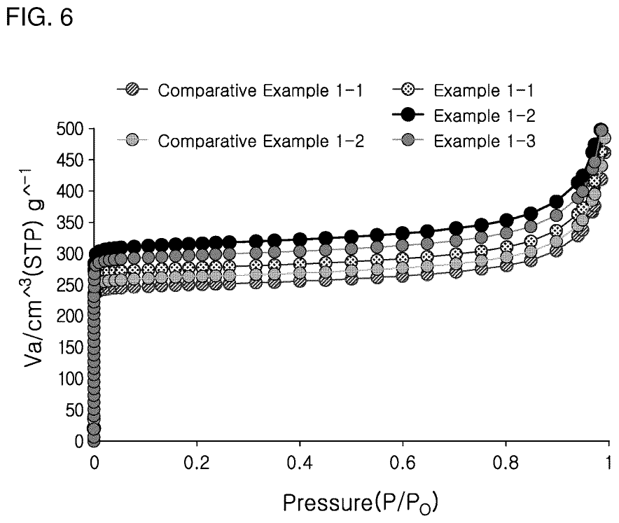

FIG. 6 is a graph showing the N₂ adsorption isotherm of the porous carbon dioxide capture agent prepared according to an embodiment of the present invention. Referring to FIG. 6, it can be confirmed that the N₂ adsorption isotherm of the porous carbon dioxide capture agent of the present invention synthesized for various reaction times shows a Type I isotherm according to the IUPAC classification. This is a result suggesting that a microporous structure exists in the porous carbon dioxide capture agent of the present invention. Furthermore, it can be confirmed that Example 1-1 shows the highest N₂ adsorption capacity, and from this result, it can be inferred that Example 1-1 has the highest pore volume.

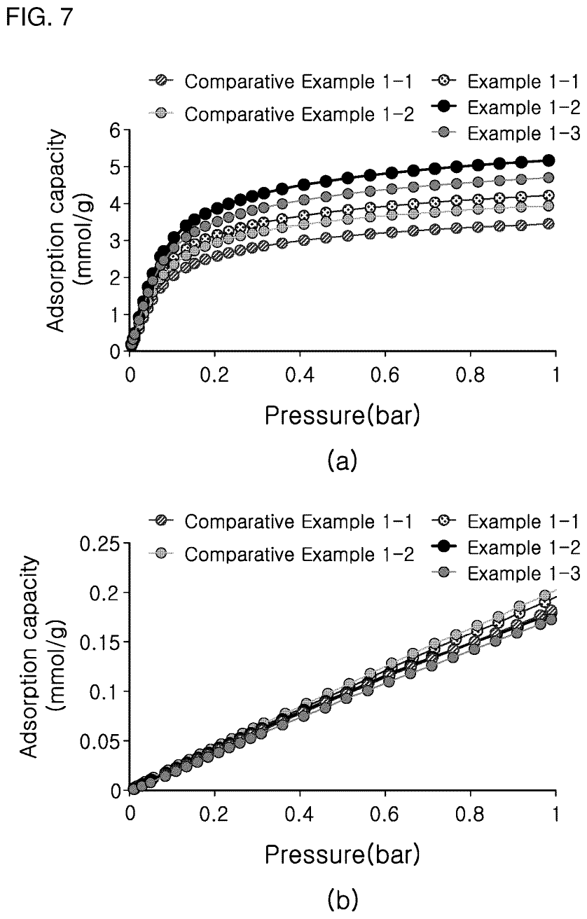

FIG. 7 is a graph showing CO₂ and N₂ adsorption isotherms of a porous carbon dioxide capture agent prepared according to an embodiment of the present invention. In order to investigate the effect of reaction time on CO₂ capture performance, CO₂ and N₂ adsorption capacities were measured separately using a volumetric method in a pressure range of 0 to 1 bar at 288 K. More specifically, (a) of FIG. 7 is a graph showing CO₂ adsorption isotherms of a porous carbon dioxide capture agent prepared according to an embodiment of the present invention, and (b) of FIG. 7 is a graph showing N₂ adsorption isotherms of a porous carbon dioxide capture agent prepared according to an embodiment of the present invention.

From the results shown in the FIG. 7, the specific surface area and pore volume of each example and comparative example were calculated and shown in Table 3 below.

TABLE 3

| | Specific surface area | Pore volume |
|---|---|---|
| Classification | (m²/g) | (cm³/g) |
| Example 1-1 | 834 | 0.76 |
| Example 1-2 | 950 | 0.86 |
| Example 1-3 | 895 | 0.81 |
| Comparative | 753 | 0.68 |
| Example 1-1 | | |
| Comparative | 792 | 0.72 |
| Example 1-2 | | |

Referring to FIG. 7 and Table 3, it can be confirmed that Comparative Example 1-1 shows the lowest CO₂ capacity due to the low crystal structure. It can be confirmed that this is consistent with the low surface area of Comparative Example 1-1 described in Table 3 above. It can be confirmed that the CO₂ capacity (3.44 mmol/g) of Comparative Example 1-1 shows a much lower result than Example 1-2 (5.1 mmol/g), which indicates that optimizing the heating time is important for carbon dioxide capture performance. In addition, the maximum CO₂ capacity can be confirmed in Example 1-2 (heating time 8 hours), which corresponds to the largest surface area and pore volume provided by the complete crystal structure of the metal organic framework. However, when the heating time exceeds 8 hours, it can be confirmed that the CO₂ capacity decreases by 10% compared to Example 1-2 (Example 1-3). In addition, it can be confirmed that the N₂ adsorption does not show an increasing trend as the reaction time increases. Based on the above results, it can be inferred that the CO₂/N₂ adsorption selectivity can be improved as the heating time increases up to 8 hours in the preparation method of the porous carbon dioxide capture agent of the present invention.

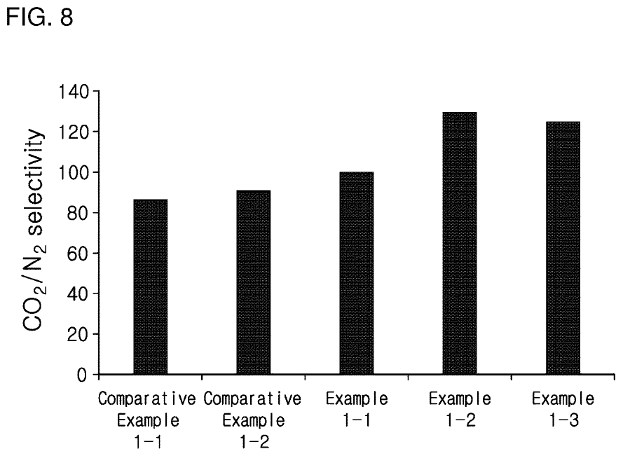

FIG. 8 is a graph showing the CO₂/N₂ selectivity of a porous carbon dioxide capture agent prepared according to an embodiment of the present invention. Referring to FIG. 8, it can be confirmed that the CO₂/N₂ selectivity gradually increases in the order of Comparative Example 1-1, Comparative Example 1-2, Example 1-1, and Example 1-2, but shows a slightly decreased value in Example 1-3. In addition, it can be confirmed that the highest CO₂/N₂ selectivity of 129 is shown in Example 1-2, where the heating time is 8 hours.

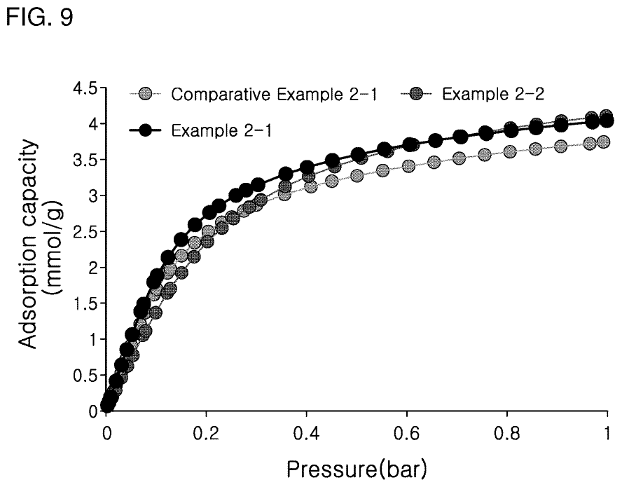

FIG. 9 is a graph showing the CO₂ adsorption isotherm of a porous carbon dioxide capture agent prepared according to an embodiment of the present invention. Referring to FIG. 9, it can be confirmed that Example 2-1 shows a CO₂ adsorption capacity of 4 mmol/g, and Example 2-2 shows a slightly higher capacity of 4.1 mmol/g. However, Example 2-2 may be less economical compared to Example 2-1 because Example 2-2 requires a heating temperature of 120° C., meaning more energy is needed to synthesize the porous carbon dioxide capture agent.

The CO₂/N₂ selectivity of the above-mentioned preparation Example 1-2 and Comparative Examples 3 to 6 are shown in Table 4 below.

TABLE 4

| Classification | CO₂/N₂ selectivity |
|---|---|
| Example 1-2 | 129 |
| Comparative Example 3 | 7 |
| Comparative Example 4 | 6.5 |
| Comparative Example 5 | 17 |
| Comparative Example 6 | 60.3 |

Referring to Table 4, it can be confirmed that the porous carbon dioxide capture agent of the present invention exhibits superior CO₂/N₂ selectivity compared to known metal organic frameworks, despite being prepared through a simple preparation method that is eco-friendly using water and can be mass-produced.

A method for preparing a porous carbon dioxide capture agent according to the present invention can be environmentally friendly as it uses only pure water as a solvent for synthesis.

Additionally, a method for preparing a porous carbon dioxide capture agent according to the present invention can be suitable for mass production through a simple preparation method.

Furthermore, a porous carbon dioxide capture agent prepared according to the method of the present invention can exhibit high CO₂/N₂ selectivity.

The above description is merely an example of the technical idea of the present invention, and those skilled in the art will appreciate that various modifications and variations may be made without departing from the essential characteristics of the present invention.

Therefore, the embodiments disclosed in the present invention are not intended to limit the technical idea of the present invention but to explain it, and the scope of the technical idea of the present invention is not limited by these embodiments. The protection scope of the present invention should be interpreted by the following claims, and all technical ideas within the equivalent scope should be interpreted as being included in the scope of the rights of the present invention.

What is claimed is:

1. A method of preparing a porous carbon dioxide capture agent, comprising:
adding a transition metal precursor, an alkali metal precursor, and an organic acid to water to prepare a metal organic framework precursor aqueous solution;
reflux condensing the prepared metal organic framework precursor aqueous solution; and
drying the condensed metal organic framework precursor aqueous solution.

2. The method of claim 1,
wherein the transition metal precursor comprises: dimethyl zinc, diethyl zinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate.

3. The method of claim 1,
wherein the alkali metal precursor comprises at least one substance selected from a group of potassium hydroxide, sodium hydroxide, lithium oxide, barium oxide, potassium carbonate, sodium carbonate, lithium carbonate, barium carbonate, sodium methoxide, sodium ethoxide, potassium ethoxide and potassium isopropoxide.

4. The method of claim 1,
wherein the organic acid is at least one substance selected from a group of acetic acid, formic acid, citric acid, oxalic acid, and ascorbic acid.

5. The method of claim 1,
wherein the transition metal precursor and the alkali metal precursor are included in a molar ratio of 1:1 to 1:5.

6. The method of claim 1,
wherein, in the reflux condensation, a heating temperature is 80 to 120° C.

7. The method of claim 1,
wherein, in the reflux condensation, a heating time is 5 to 10 hours.

8. The method of claim 1,
wherein, the drying is performed in a vacuum.

9. A porous carbon dioxide capture agent formed using a composition comprising a transition metal precursor, an alkali metal precursor, and an organic acid.

10. The capture agent of claim 9,
wherein a specific surface area of the porous carbon dioxide capture agent is 750 to 1000 m²/g.

11. The capture agent of claim 9,
wherein a pore volume of the porous carbon dioxide capture agent is 0.6 to 1.0 cm³/g.

12. The capture agent of claim 9,
wherein CO₂/N₂ selectivity of the porous carbon dioxide capture agent is 110 to 130.

13. The capture agent of claim 9,
wherein X-ray diffraction (XRD) spectrum peaks (2θ) of the porous carbon dioxide capture agent formed appear at 7.4°, 11.26°, 13.61°, 15.5°, 21.19°, 25.28°, 26.22°, 27.99°, 28.8°, 35.63° and 37.17°.
